(19) United States
(12) Patent Application Publication
(10) Pub. No.: US 2004/0063071 A1
(43) Pub. Date: Apr. 1, 2004

(54) Dental implant having threads with variable depth

(76) Inventor: Schroering, (US)

Correspondence Address: Joan L. Simunic, 4719 Grand Dell Drive, Crestwood, KY, 40014, US

(21) Appl. No.: 10/260,368

(22) Filed: Sep. 30, 2002

(51) Int. Cl. A61C 8/00

(52) U.S. Cl. 433/174

(57) ABSTRACT

A dental implant having threads on the exterior surface that vary in depth but maintain an essentially constant number of turns per axial inch is described. Near a distal end of the implant, the threads have a relatively shallow depth. Near a proximal end, the threads have a depth about twice as deep as near the distal end. Optionally, the implant may include a coating to facilitate anchoring on the proximal end threads. Further, the implant may be self-tapping or it may be tapered.

### BACKGROUND

The present invention is a dental implant, and more particularly to a dental implant having threads on the exterior surface that vary in depth but maintain an essentially constant pitch.

Dental implants are embedded in the jaw bone and serve to anchor one or more artificial teeth or dentures. Important to the success of such devices is the rigid anchoring of the implant in the bone, and several journal articles and patents have proposed various methods for achieving rigid anchoring (see U.S. Pat. No. 5,344,457 and incorporated herein by reference). For example, U.S. Pat. No. 4,713,003, issued to Symington et al. describes an implant that has a tapered external body, resulting in a better distribution of the stresses acting on the device in situ than is achieved with cylindrical body implants. U.S. Pat. No. 5,344,457, issued to Pilliar et al, describes an implant that has a body with a nonporous surface on the upper portion of the implant and a porous surface on the lower portion of the implant. The porous surface provides interstices into which bone is permitted to grow once the implant is accommodated within the bone.

As reported in U.S. Pat. No. 5,527,183, issued to O'Brien, and incorporated herein by reference, an implant design that is capable of more evenly distributing occlusal loads along the entire length of the implant connection member can be effective in preventing the implant from loosening over time. The '183 patent claims a multi-segmented device wherein each segment includes a frusto-conical tension moiety and a frusto-conical compression moiety. While the '183 patent recognizes that the thread design on the exterior surface of the implant can affect the securing of the implant to the jawbone, the '183 patent focuses on the threads closest to the distal end of the implant without concern about the threads closer to the proximal end of the implant. In particular, the '183 patent fails to teach any relationship between the threads at one end relative to the threads at the other end.

In U.S. Pat. No. 5,588,838, issued to Hansson et al, the exterior surface of the implant near the distal end is provided with a circumferentially or tangentially oriented, defined micro-roughness having a height which may vary between 0.02 and 0.20 mm. The micro-roughness may be microthreads or microbeads. The low height of the microthreads allows new bone tissue to rapidly grow into the microthreads, and bone resorbtion does not occur. Similar to the device of the '183 patent, the '838 patent teaches the importance of careful design of the threads near the distal end of the implant, but fails to teach any relationship between the threads at the distal end relative to the threads at the proximal end.

### SUMMARY OF THE PREFERRED EMBODIMENT

The present invention is a dental implant having threads on the exterior surface that vary in depth but maintain an essentially constant pitch. Near a distal end of the implant, the threads have a relatively shallow depth. Near a proximal end, the threads have a depth about twice as deep as near the distal end. The thread pitch (turns per axial inch) is essentially the same for the distal end threads and for the proximal end threads. By maintaining the pitch, the distal end threads fit into jaw bone cuts made by the proximal end threads. Because the thread depth varies, the shallower depth of the distal end threads anchor the implant in relatively dense cortica bone whereas the proximal end threads anchor the implant in relatively porous cankerous bone. Optionally, the implant may include a coating to facilitate anchoring on the proximal end threads. Further, the implant may be self-tapping or it may be tapered.

### DESCRIPTION OF FIGURES

FIG. 1 is a perspective view of a dental implant made in accordance with the present invention anchored in a lower jaw bone;

FIG. 2 is a side view of the dental implant of FIG. 1;

FIG. 3 is a cross-sectional view of the distal end threads taken along line 3-3;

FIG. 4 is a cross-sectional view of the proximal end threads taken along line 4-4; and

FIG. 5 is a top view of the dental implant of FIG. 1.

### DETAILED DESCRIPTION OF THE PREFERRED EMBODIMENT

The dental implants depicted in the various Figures are selected solely for the purposes of illustrating the invention. Other and different dental implants may utilize the inventive features described herein as well.

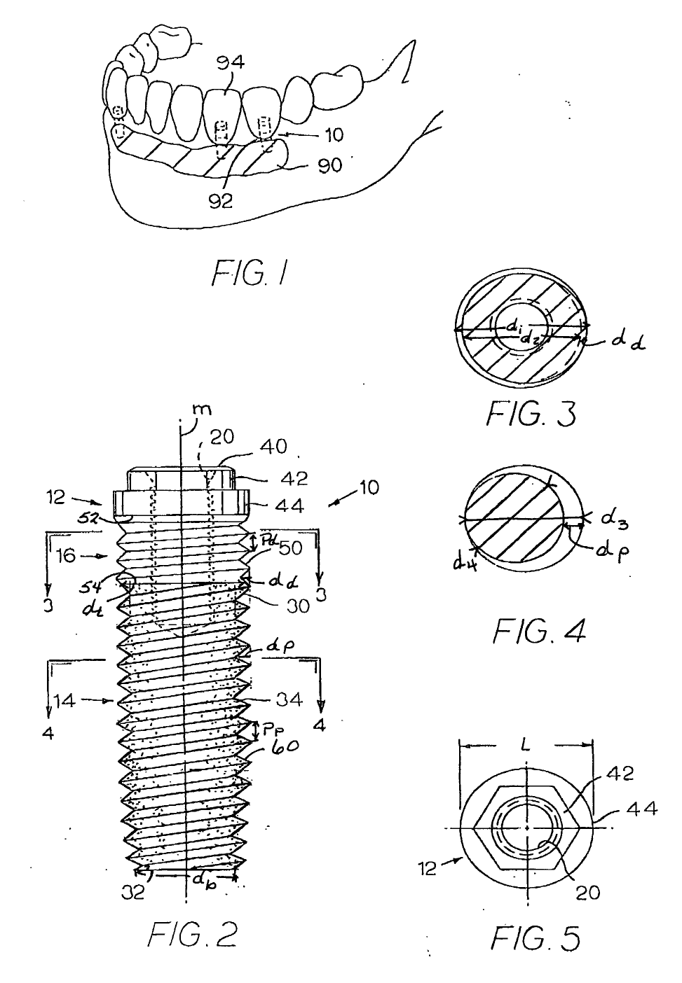

Reference is first made to FIGS. 1 through 5 in which the dental implant constructed in accordance with the present invention is generally noted by the character numeral 10. The dental implant 10, which defines a distal end 41 and a proximal end 32, has as major components a head 12, a proximal end threaded region 14, and a distal end threaded region 16. As is known in the art, the implant 10 includes a bore 20. The implant 10 has an axial length, L, defined as the distance between the distal end 41 and the proximal end 32.

As shown in FIG. 1, the implant 10 is mounted in a cavity 92 bored into the jaw bone 90 of the patient such that the proximal end threaded region 14 extends into the jaw bone 90. After the implant 10 is anchored in the jaw bone 90, a bridge or artificial tooth 94 can be secured to the implant 10, as is known in the art. The implant 10 can be formed from any smooth hard material commonly known in the art as being suitable for dental implants. In the preferred embodiment, the implant 10 is machined from a titanium alloy.

As shown in FIGS. 2 and 3, between the head 12 and the proximal end threaded region 14 is the distal end threaded region 16, having a thread 50 that circumscribes the region 16. The thread 50 defines an outer diameter, d₁, and an inner diameter, d₂. The difference between the outer diameter d₁ and the inner diameter d₂ defines a distal end thread depth, d_{d}. The thread 50 circumscribes the distal end threaded region 16 so as to define a predetermined number of turns per axial inch or a pitch. The pitch is inversely proportional to the spacing, pd, between two axially adjacent points on the thread 50. The distal end thread 50 serves to anchor the implant 10 in the relatively dense cortica bone the jaw bone 90. The exterior surface of the distal end thread 50 can be smooth, beaded (such as described in U.S. Pat. No. 6,379,153, issued to Schroering, and incorporated herein in its entirety by reference), or roughened by other techniques known in the art, and in the preferred embodiment, the surface is smooth. The number of turns in the distal end threaded region 16 can vary, but 3 to 5 turns is preferable. The distal end threaded region 16 is delimited by a top 52 and a bottom 54. The top 52 is adjacent to the head 12 and the bottom 54 is adjacent to the proximal end threaded region 14. In a preferred embodiment, the distal end threaded region 16 is essentially cylindrical, i.e. an exterior diameter of the top 52, d₅₂, is essentially equal to an exterior diameter of the bottom 54, d₅₄. Alternatively, the distal end threaded region 16 may include a slight taper wherein d₅₂ is slightly greater than d₅₄.

As shown in FIGS. 2 and 4, the proximal end threaded region 14, having a thread 60, is delimited by a top 30 and a bottom 32. The top 30 is adjacent to the distal end threaded region 16. The thread 60 have an outer diameter, d₃, and an inner diameter, d₄. The difference between the outer diameter d₃ and the inner diameter d₄ defines a proximal end thread depth, dₚ. The proximal end thread depth dₚ must be greater than the distal end thread depth d_{d}. In a preferred embodiment, the proximal end thread depth dₚ is about two times the distal end thread depth d_{d}. The thread also defines a pitch or a specific number of turns per axial inch. The pitch is inversely proportional to the spacing, pₚ, between two axially adjacent points on the thread 60. The spacing pₚ for the thread 60 preferably is essentially equal to the spacing pd of the thread 50. The proximal end thread 60 serves to anchor the implant 10 in the relatively porous cankerous bone of the jaw bone 90.

In the embodiment shown in FIGS. 2 and 4, the proximal end threaded region 14 is tapered and has a frusto-conical shape wherein the exterior diameter of the top 30, d₃₀, is greater than the exterior diameter of the bottom 32, d₃₂. In a preferred embodiment, the taper angle of the proximal end threaded region 14 is preferably a Morris taper, i.e. a taper angle of less than about 8°, and most preferably the taper angle of the proximal end threaded region 14 is approximately 7°. Alternatively, the proximal end threaded region 14 may be essentially cylindrical, i.e. the exterior diameter of the top 30, dₜ, may be essentially equal to the exterior diameter of the bottom 32, d_{b}. Optionally, the proximal end threaded region 14 may have a porous or beaded surface 34 comprised of a network of discrete particles which provides interstices into which bone is permitted to grow once implant 10 is accommodated within the bone 90 (see U.S. Pat. No. 6,379,153).

As shown in FIGS. 2 and 5, the head 12 of the implant 10 defines an external hex—a projection 42 with a distal end 41, having a planar surface 40—which allows the implant specialist to seat the implant, and a neck 44. The exterior surfaces of the projection 42 and neck 44 are smooth so that bone anchoring and bacterial accumulation will be deterred. The neck 44 abuts the distal end threaded region 16, and preferably has a rounded periphery with an exterior diameter d₅ essentially equal to the outside diameter of the threads of the distal end threaded region 16, d₁. The projection 42 extends from the neck 44 away from the proximal end threaded region 14, and serves as a wrench-engaging surface for the implant specialist and as a key for aligning the artificial tooth 94. Preferably the projection 42 has a periphery that defines a hexagonal shape, although other shapes may be defined as necessary to accommodate commercially available implantation tools. As is known in the art, essentially the same functional features can be obtained by use of an internal hex, and the internal hex may be substituted for the external hex in the present invention. From the distal end planar surface 40 a bore 20 extends vertically into but not through the implant 10 along the midline “m”. The bore 20 is preferably screw-threaded so as to engage a retaining screw (not shown) to secure the bridge or artificial tooth 94 to the implant 10.

Several optional features, known in the art and not shown herein, may be included in the implant 10. For example, the implant 10 may be self-tapping to allow the implant to enter the jaw bone more easily. Further, the implant 10 may include a cutting thread at the interface between the proximal end threaded region 14 and the distal end threaded region 16. Cutting threads are commonly used to help seat the dental implants.

The dental implant 10 has threads 50, 60 on the exterior surface that vary in depth but maintain an essentially constant pitch. The depth variation, and specifically having a greater thread depth near the proximal end 14 as compared to the thread depth near the distal end 16, provides that there is an increased surface area in the softer cankerous bone. This results in the implant having greater primary stability which is essential for integration of the implant in the bone.

It is understood that, in light of a reading of the foregoing description and drawings, those with ordinary skill in the art will be able to make changes and modifications to the present invention without departing from the spirit or scope of the invention, as defined herein. For example, although the embodiments presented herein refer to the threads in the singular form, those skilled in the art may accomplish the same depths and relative spacings by using a plurality of threads.

What is claimed is:

1. A dental implant for anchoring in bone, said implant defining a distal end and a proximal end, and having an axial length defined as the distance between the distal end and the proximal end, said implant comprising:
a. a distal end threaded region with a first thread, said first thread defining a first thread depth, d_{d}, and said first thread circumscribing said distal end threaded region so as to define a first predetermined number of turns per axial inch, p_{d};
b. a proximal end threaded region with a second thread, said second thread defining a second thread depth, dₚ, and said second thread circumscribing said proximal end threaded region so as to define a second predetermined number of turns per axial inch, pₚ;
c. a head, having a neck abutting said distal end threaded region and having a wrench-engaging projection extending from the neck away from said distal end threaded region, the projection defining a top planar surface, and the neck and the projection having smooth exterior surfaces; and
d. a bore which protrudes along the midline from the top surface of the head projection through said head and through said distal end threaded region and into said proximal end threaded region, said bore terminating within said proximal end threaded region,
wherein said second thread depth, dₚ, is greater than said first thread depth, d_{d}, and said first predetermined number of turns per axial inch, p_{d}, is essentially equal to second predetermined number of turns per axial inch, pₚ.

2. The implant of claim 1 wherein said second thread depth, dₚ, is about two times said first thread depth, d_{d}.

3. The implant of claim 1 wherein said first thread has from about three to about five turns per axial inch.

4. The implant of claim 1 wherein said proximal end threaded region defines a top adjacent said distal end threaded region, and said proximal end threaded region has a frusto-conical shape wherein the exterior diameter of the top is greater than the exterior diameter of the proximal end.

5. The implant of claim 4 wherein said proximal end threaded region is tapered at a taper angle of less than about 8°.

6. The implant of claim 1 wherein said proximal end threaded region defines a top adjacent said distal end threaded region, and said proximal end threaded region has an essentially cylindrical shape wherein the exterior diameter of the top is essentially the same as the exterior diameter of the proximal end.

7. The implant of claim 1 wherein said distal end threaded region has a smooth surface.

8. The implant of claim 1 wherein said distal end threaded region has a surface which is beaded.

9. The implant of claim 1 wherein said distal end threaded region has a surface which is roughened.

10. The implant of claim 1 wherein said proximal end threaded region has a surface which is beaded.

11. The implant of claim 1 wherein said wrench-engaging projection has a hexagonal shape.

12. The implant of claim 1 wherein said bore is threaded to accommodate a retaining screw.

13. The implant of claim 1 wherein said implant is made from titanium alloy.

14. The implant of claim 1 wherein said implant is self-tapping.

15. The implant of claim 1 wherein said implant further includes a cutting thread at the interface between the proximal end threaded region and the distal end threaded region.

16. A dental implant for anchoring in bone, said implant defining a distal end and a proximal end, and having an axial length defined as the distance between the distal end and the proximal end, said implant comprising:
a. a distal end threaded region with a first thread, said first thread defining a first thread depth, d_{d}, and said first thread circumscribing said distal end threaded region so as to define from about three to about five turns per axial inch, p_{d};
b. a proximal end threaded region with a second thread, said second thread defining a second thread depth, dₚ, greater than said first thread depth, d_{d}, and said second thread circumscribing said proximal end threaded region so as to define about three to about five turns per axial inch, pₚ;
c. a head, having a neck abutting said distal end threaded region and having a wrench-engaging projection extending from the neck away from said distal end threaded region, the projection defining a top planar surface, and the neck and the projection having smooth exterior surfaces; and
d. a bore which protrudes along the midline from the top surface of the head projection through said head and through said distal end threaded region and into said proximal end threaded region, said bore terminating within said proximal end threaded region.

17. The implant of claim 16 wherein said second thread depth, dₚ, is about two times said first thread depth, d_{d}.

18. The implant of claim 16 wherein said proximal end threaded region defines a top adjacent said distal end threaded region, and said proximal end threaded region has an essentially cylindrical shape wherein the exterior diameter of the top is essentially the same as the exterior diameter of the proximal end.

19. A dental implant for anchoring in bone, said implant defining a distal end and a proximal end, and having an axial length defined as the distance between the distal end and the proximal end, said implant comprising:
a. a distal end threaded region with a first thread, said first thread defining a first thread depth, d_{d}, and said first thread circumscribing said distal end threaded region so as to define a first predetermined number of turns per axial inch, pd;
b. a proximal end threaded region with a second thread, said second thread defining a second thread depth, dₚ, that is about two times said first thread depth, d_{d}, and said second thread circumscribing said proximal end threaded region so as to define a second predetermined number of turns per axial inch, pₚ;
c. a head, having a neck abutting said distal end threaded region and having a wrench-engaging projection extending from the neck away from said distal end threaded region, the projection defining a top planar surface, and the neck and the projection having smooth exterior surfaces; and
d. a bore which protrudes along the midline from the top surface of the head projection through said head and through said distal end threaded region and into said proximal end threaded region, said bore terminating within said proximal end threaded region.

20. The implant of claim 19 wherein said first thread has from about three to about five turns per axial inch.
